(19) United States
(12) Patent Application Publication
(10) Pub. No.: US 2016/0180270 A1
(43) Pub. Date: Jun. 23, 2016

(54) OPTIMIZATION OF PROJECT RESOURCE MANAGEMENT WITH MULTI-RESOURCE TYPES AND COST STRUCTURES

(71) Applicants: Gufei SUN, Shanghai (CN); Heng WANG, Shanghai (CN); Yu CHENG, Shanghai (CN); Wen-Syan LI, Shanghai (CN)

(72) Inventors: Gufei SUN, Shanghai (CN); Heng WANG, Shanghai (CN); Yu CHENG, Shanghai (CN); Wen-Syan LI, Shanghai (CN)

(21) Appl. No.: 14/574,397

(22) Filed: Dec. 18, 2014

(51) Int. Cl. G06Q 10/06

(52) U.S. Cl. CPC G06Q 10/06313

(57) ABSTRACT

Disclosed herein are technologies related to an optimization of project resource management of projects having multiple resource types and cost structures. One or more the technologies involves optimizing a project based, at least in part, on project data and related resource data using successive genetic operations and evaluations and further producing a resource-acquisition plan for the optimized project.

### TECHNICAL FIELD

The present disclosure relates generally to an optimization of project resource management of projects having multiple resource types and cost structures.

### BACKGROUND

Generally, project management is a label used to describe the purposeful preparation for and implementation of a plan to execute a project to a successful completion. In this sense, a project is a discrete endeavor with a defined goal, such as producing a product, service, or some other desired result. The endeavor is discrete because it typically has a defined beginning and end (usually time-constrained, and often constrained by funding or deliverables) and it is undertaken to meet unique goals and objectives. Said another way, a project is a process and activity of planning, organizing, motivating, and controlling resources to achieve specific goals.

The primary challenge of project management is to achieve the project goals and objectives while honoring the preconceived constraints. This often involves maximizing resource usage rate for the allocated budget (or generally least cost). The resource usage rate is the rate at which resources are used over a defined period of time. In project management terminology, resources are required to carry out the project tasks. The resources can be human labor, equipment, facilities, funding, or nearly anything else capable of definition required for the completion of a project activity. The lack of a resource will therefore be a constraint on the completion of the project activity.

### SUMMARY

Disclosed herein are technologies related to an optimization of project resource management of projects having multiple resource types and cost structures. One or more the technologies involves optimizing a project based, at least in part, on project data and related resource data using successive genetic operations and evaluations and further producing a resource-acquisition plan for the optimized project.

With these and other advantages and features that will become hereinafter apparent, further information may be obtained by reference to the following detailed description and appended claims, and to the figures attached hereto.

### BRIEF DESCRIPTION OF THE DRAWINGS

FIG. 1 illustrates an exemplary system;

FIG. 2 illustrates an exemplary process;

FIG. 3 illustrates an exemplary process; and

FIG. 4 illustrates an exemplary computing system to implement in accordance with the technologies described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies related to the optimization of project resource management of projects having multiple resource types and cost structures. One or more the technologies described herein involve optimizing a project based, at least in part, on its project data and related resource data using successive genetic operations and evaluations and further producing a resource-acquisition plan for the optimized project.

While the technology described herein may be implemented in numerous ways and with various applications, the primary implementation discussed herein involves management of human resources for a project. With this primary implementation, several types of candidate resources are available, such as full time employees (FTEs), interns, and contractors as human resources. These resources are with different productive capacities and disparate cost structures.

Typically, an organization (e.g., company or plant) obligates itself to complete a number of projects during a period (e.g., year). According to its obligation, the organization must complete the project to its own specifications by its deadline. Without loss of generality, herein it is assumed that the various constraints (e.g., cost structures) of a project are measurable and prediction of projects for the next time period is known.

One of the results of the technology described herein is to produce an overall project plan that meets the prescribed timeline meanwhile minimize cost of resources. This may be accomplished by, first, configuring different resources in each project and consider them as several single resource projects with the same project period equivalently. Then, all the projects may be reformed and the real project period is calculated according to resources invested. After that, these projects with assigned resources are optimized by genetic algorithm, which must meet deadline of each project.

The genetic algorithm is applied to solve complexity of multiple resources and flexible time span in project management problem. This work can be easily generalized into tasks with time table, including a start time and an end time, and the workload could be measured evenly. Moreover, the resources denotes to production unit with quantifiable cost and efficiency.

A project period is often flexible. For example, the time period could be adjusted if more resources are invested at a time while delay may happen if there is any shortage of resources. A number of independent resources types, such as different roles are required and involved in one project.

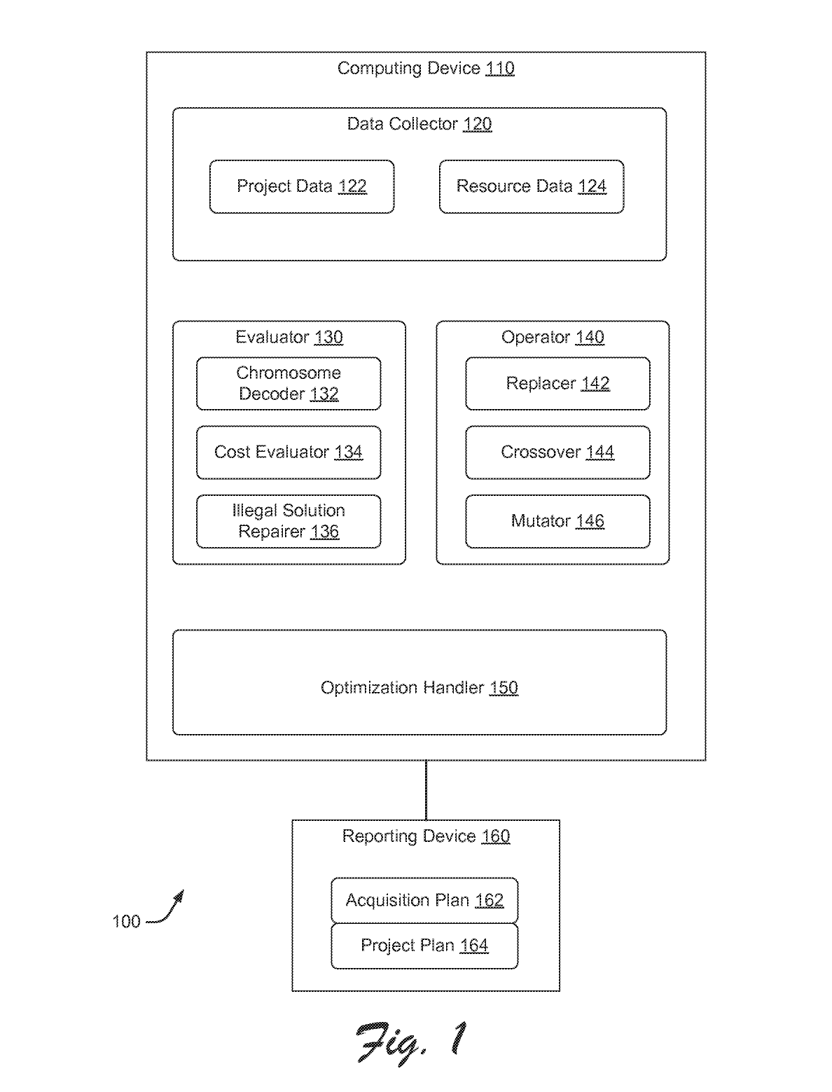

FIG. 1 shows an example computing system 100 that is an example implementation of the technology described herein. The computing system 100 includes a computing device 110 (e.g., desktop computer, server, laptop, tablet computer, smartphone, etc.) with a reporting device 160. The computing device 110 includes a data collector 120, an evaluator 130, operator 140 and an optimization handler 150. The data collector 120 may be implemented, for example, as its own database server or as storage system of a sole computing system.

In an exemplary project such as web development or software update, workers having differing roles typically accomplish this type of typical project. For example, a project may call for five different roles (e.g., UX designer, UI front-end developer and middle-layer developer, etc.). The project with multiple roles is converted to several projects with single role, where these reformed projects take the same project period, which may be equivalent to the original one. So, the project with five different roles is handled as five different projects (or perhaps sub-projects), where each sub-project has its own single role assigned. For simplicity of discussion, the following description focuses on a single role.

For a particular project, a database server (such as the data collector 120) is configured to store project data 122 about that project. The project data 122 includes information associated with the particular project. The information, for example, includes a project identification, project start time (i.e., kick-off time), project delivery time, and an expected-project-completion load.

The project identification is the unique name or ID of the project. The project start time is the kick-off or time (or day) of the beginning of the project. The project delivery time is the deadline (time or day) that the project must be completed. The expected-project-completion load is the quantifiable amount of work, consumables, etc., that must be used to complete the project. For a human-resources project, the expected-project-completion load is the workload, which is the amount of work that has to be done to complete the project. For example, the project may take eighty man-days of work.

Among the listed attributes, the kick-off time is usually fixed and the project could be finished ahead of time but not be postponed. In other words, the delivery time could be advanced by investing more human resources.

At the stage of planning, it is assumed that there is a number of N of candidate projects P₁, . . . , P_{N}. The number N of potential or planned projects is typically larger than what can be developed with the current available human resources. That makes the need to recruit new employees to deliver the projects in time. Each project P may have a predefined kick-off time TK_{P} and an expected delivery time TD_{P}. For each of the projects, there may be a correspondence workload W_{P}.

There are various types of human resources. At the stage of planning, it is assumed that there is a number of M candidate types of employees E₁, . . . , E_{M}. For example, three types of employees are discussed: Full Time Employee (FTE), Intern and Contract Labor, which are represented as E₁, E₂, and E₃, respectively.

There are differences in the productivity (i.e., skill-level) and cost structures of various employees. For example, FTE are generally more productive; interns are cheaper but less productive; and contractors may be as productive as FTE but more expensive. In order to accommodate this, an average skill level is introduced with a normalized productivity factor of 1.0. One man-day is defined as a normal FTE's workload a day. This normalization more accurately accounts for the average productivity of the different types of employees. For example, a typical FTE takes productivity of 1.0 man-day while an intern takes only productivity 0.6 man-day.

The daily cost and productivity of different types of employee E₁, . . . , E_{M} may be defined as C₁, . . . , C_{M} and Prod₁, . . . , Prod_{M} respectively.

One difference between FTE and other types of employee is that the FTE can be used continuously to the subsequent new project or transferred to ongoing project to speed up the project. Therefore, the delivery time of each project could be changed according to the investment of workforce. In this way, dependency among projects may be considered in the modeling. The assignment takes into account the productivity of the developers, their availability, and the possible dependencies between tasks.

For this particular project, the database server (such as the data collector 120) is configured to store resource data 124. That resource data 124 includes information regarding each resource available for use with the subject project to complete that project. The information for each resource, for example, includes a resource-type identification, productivity rate, resource cost, resource-acquisition cost, and resource-availability information.

The resource-type identification identifies the type of resource (e.g., different types of employees) for the resource. In addition, there may be a resource identification that identifies the particular resource itself.

The productivity rate is the measure of the rate at which the resource completes the work or provides supplies for purpose of fulfilling the expected-project-completion load to determine if the project is completed. For instance, in the human-resources example, the productivity of an employee is a measure of the employee's skill as measured in man-days (or the like).

Collectively, the resource cost and resource-acquisition cost are known as the cost structure of the resource. The resource cost is a measure of how expensive the resource is to retain or use on a regular basis. For example, in the case of a FTE, the resource costs include the employee's pay, benefits, supplies, and associated overhead. The resource-acquisition cost is the expenses involved in acquiring the resource. For example, the cost of recruiting a new employee is the resource-actuation cost of a particular type of employee.

Based on the budget and policy of the company, there are limits about the headcount for recruiting different types of employees. Usually there is a budget ceiling, Budgetₜₒₜₐₗ, for recruiting. And there is also maximum recruiting limit for each type of employee, which may be defined as Ceil_{E}_{₁}, . . . , Ceil_{E}_{_{M}}.

The evaluator 130 includes a chromosome decoder 132, cost evaluator 134, and an illegal solution repairer 136.

The chromosome decoder 132 decodes (and possibility initially encodes) each chromosome being evaluated. Each chromosome has the potential solution depicted (or encoded) in its data structure. The chromosome decoder 132 decodes or interprets the contents of that data structure. For example, the chromosome may be decoded to include five FTEs, three contractors, and two interns.

The cost evaluator 134 determines the cost of the decoded chromosome that is being considered. The information for each resource includes a resource-type identification, productivity rate, resource cost, resource-acquisition cost, and resource-availability information. The cost of a particular chromosome will be based upon the cost information of the resources depicted by that chromosome.

The illegal solution repairer 136 repairs or adjusts for illegal solutions that may be generated by the chromosome generation or operation (e.g., crossover). An illegal solution is one that when decoded from a particular chromosome fails to represent an actual or valid solution to the problem (e.g., human resource optimization for project). The illegality of chromosomes originates from the nature of the encoding technique. For many combinatorial optimization problems, problem specific encoding techniques are used and these often yield illegal offsprings by simple one-cut point crossover operation. Because illegal chromosomes cannot be decoded to an effective solution, repair techniques are used to convert an illegal chromosome to a legal one.

The operator 140 includes a replacer 142, a crossover unit 144, and a mutation unit 146.

The replacer 142 performs selection and replacement of chromosomes. Typically, when picking (as in a selection or replacement), parent chromosomes elitism and diversity are considered. Elitism is the process of selecting new parent chromosomes (which may be called replacement) because they are better solution than the previous parents. Elitism allows the solutions to get better over time. Diversity allows the genetic algorithm to search through a wider variety of solutions, and thereby not get stuck in local maxima (i.e., solutions that seem good locally, but are not overall). This can be done by adding a random parameter to the elitist selection scheme. For example, using a tournament selection scheme, which involves comparing random numbers scaled by the magnitude of the fitness.

The crossover unit 144 performs a genetic operator that varies the programming of a chromosome or chromosomes from one generation to the next. It is analogous to reproduction and biological crossover, upon which genetic algorithms are based. Crossover is a process of taking more than one parent solutions and producing a child solution from them.

The mutation unit 146 performs a genetic operator used to maintain genetic diversity from one generation of a population of genetic algorithm chromosomes to the next. It is analogous to biological mutation. Mutation alters one or more gene values in a chromosome from its initial state. In mutation, the solution may change entirely from the previous solution.

The reporting device 160 includes mechanisms for communicating with a human. For example, the reporting device 160 may include one or more of the following components or features: display system, graphical user interface, user interface, printer, messaging system (e.g., email or SMS messages), or the like.

The reporting device 160 reports the resulting resource-acquisition plan 162 to the user. It also reports the plan(s) 164 for each individual project (or subprojects) and/or for the overall collection of projects.

For the human-resources project being discussed, the resource-acquisition plan 162 may be called a recruitment plan because the primary way to acquire the required employees is via recruitment. The recruitment plan may include information regarding recruitment timing, employee type, and quantity. With this information, the human resources department may determine how many (“quantity”) types of employee (“employee type”) to recruit during recruitment timing.

For the human-resources project being discussed, the project plan 164 indicates the project information with more detail, such as updated expected end time and the number of each type of employee used for performing the project. The project plan 164 may include information regarding a unique project name or identification, expected end time of the project, number of FTE workers for this project, number of intern workers for this project, and number of contract workers for this project.

If companies overdo the size of their workforce, it will carry surplus or underutilized staff. Alternatively, if the opposite misjudgment is made, employees may be overstretched. This makes it hard or impossible to meet production or service deadlines at the quality level expected. Therefore, the planning objective is lowest cost of workforce while at the same time guaranteeing all the projects can be finished before the deadline.

Some portion of the components of system 100 may include a database server. That may be called a database, data storage system, storage system, or the like. Such a server or system may store input data (such as project and resource data) and resulting data (such as the resource-acquisition plan or project plan).

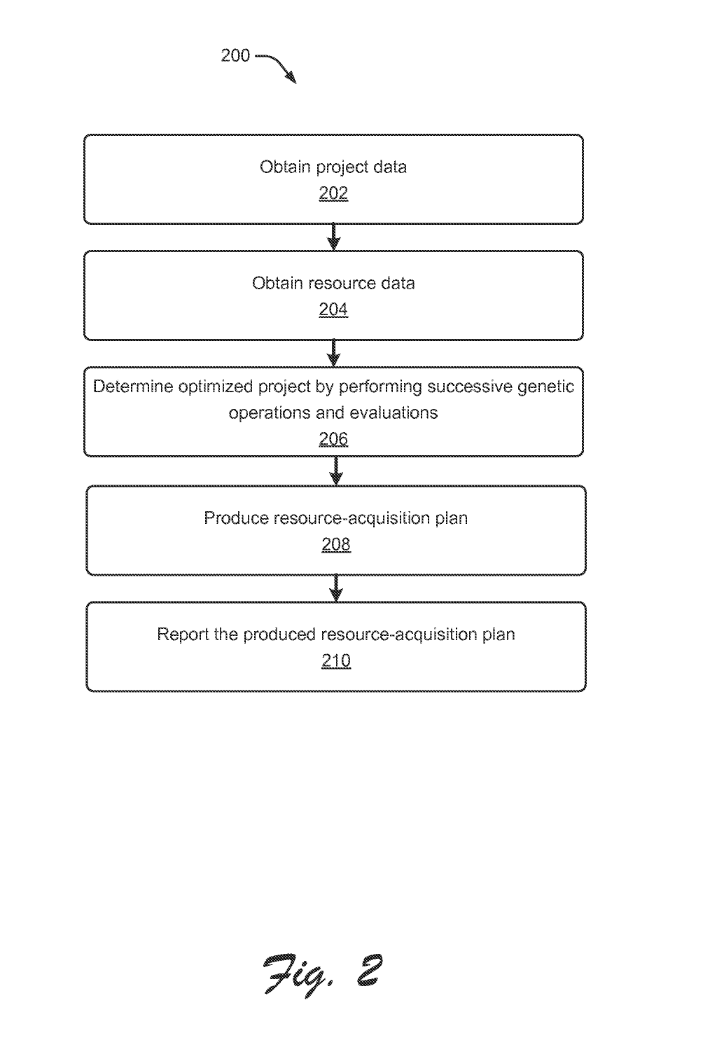

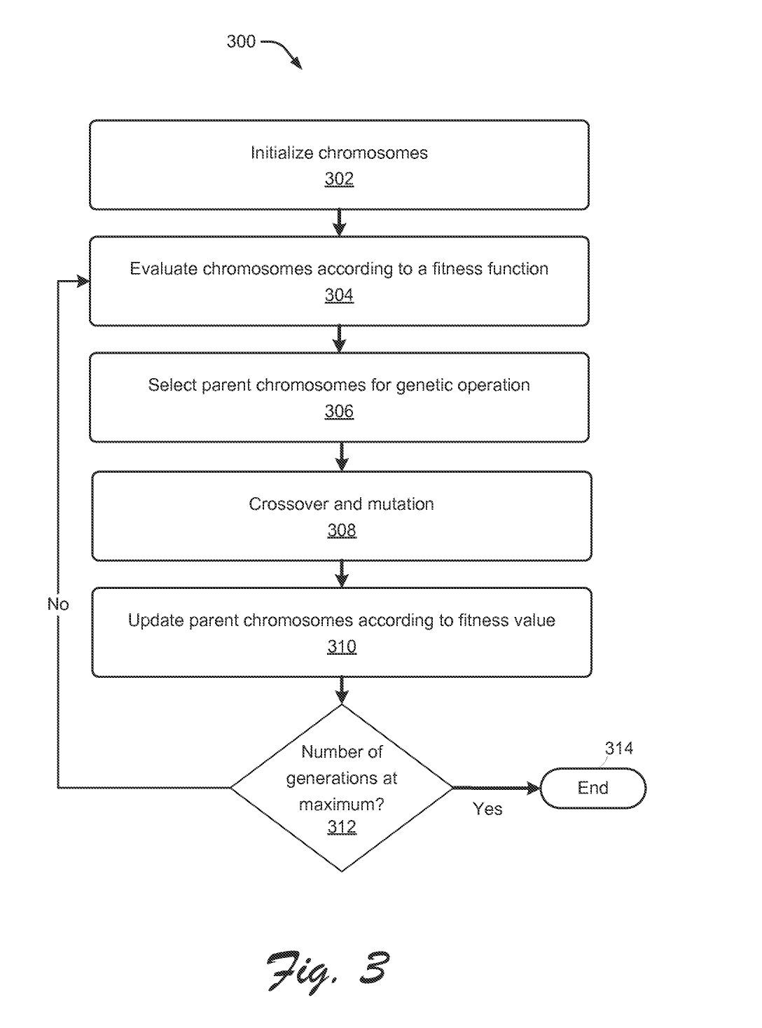

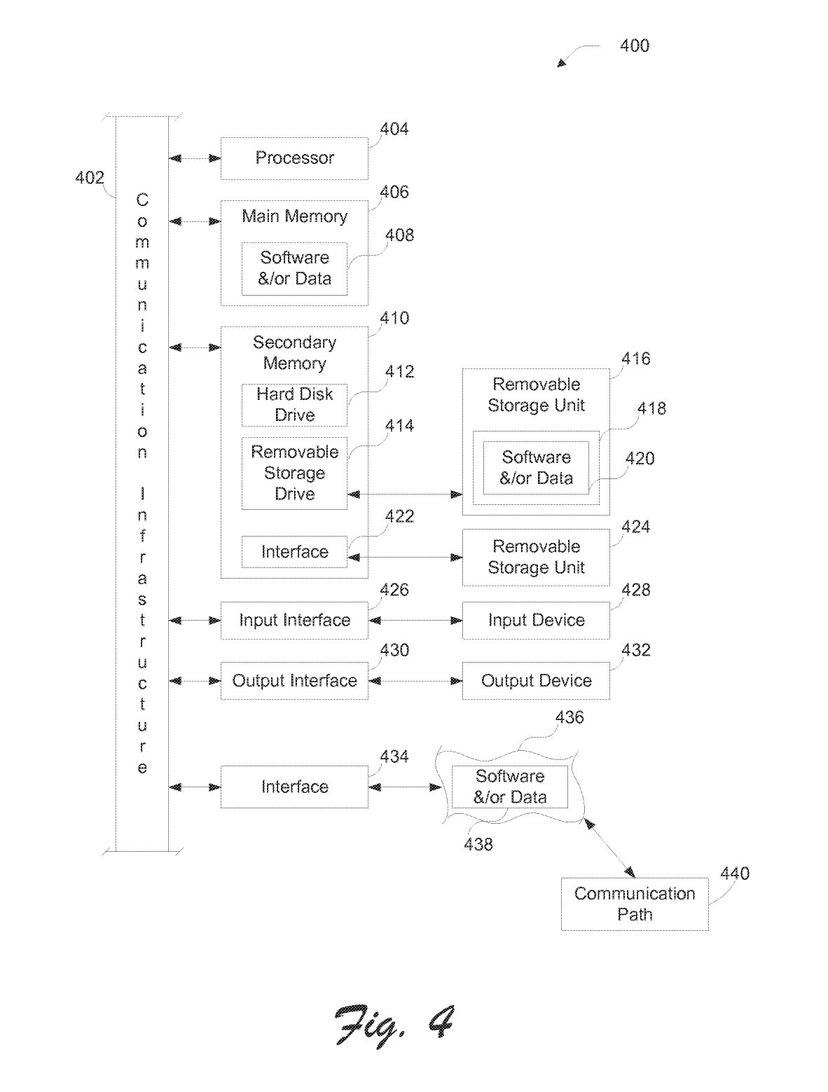

FIGS. 2 and 3 illustrates exemplary processes 200 and 300 for implementing, at least in part, the technology described herein. In particular, process 200 depicts an optimization of a project based, at least in part, on its project data and related resource data using successive genetic operations and evaluations and then producing a resource-acquisition plan for the optimized project. The process 200 may be performed by a computing device or devices. An example architecture of such a computer device is described below with reference to FIG. 4.

For the human-resources project being discussed, the process 200 aims to minimize the cost of recruiting human resources. Meanwhile, the budget and delivery date are considered too. When the number of projects and types of employee are large, the minimization is a NP-hard problem. The technologies described herein utilize a generic algorithm (GA) for optimizing based on a natural selection process that mimics biological evolution. The process 200 repeatedly modifies a population of individual solutions. Along the way, the process 200 randomly selects individuals from the current population and uses them as parents to produce the children for the next generation. Over successive generations, the population “evolves” toward an optimal solution.

At 202, a computing device obtains project data regarding a subject project from a database server configured to store project data about the subject project. The project data includes information associated with the subject project. The information includes a project identification, project start time, project delivery time, and an expected-project-completion load.

At 204, the computing device obtains resource data from the database server. The resource data includes information regarding each resource available for use with the subject project to complete that project. The information for each resource includes a resource-type identification, productivity rate, resource cost, resource-acquisition cost, and resource-availability information.

In this example, each of the multiple types of resources differ from each other in the values of their respective associated information regarding any one or a combination of the productivity rate, the resource cost, the resource-acquisition cost, or the resource-availability information. Also, in this example, each of the multiple types of resources differ from each other in the values of their respective cost structure, where the cost structure of a resource is the associated information regarding the resource cost, the resource-acquisition cost, or the resource-availability information.

At 206, the computing device determines an optimized project based, at least in part, on the obtained project data and the obtained resource data. In one implementation, the determination includes performing successive genetic operations and evaluations. FIG. 3 depicts the example process 300 that performs successive genetic operations and evaluations in accordance with this example process 200.

At 208, the computing device produces a resource-acquisition plan for the optimized project. The resource-acquisition plan includes information associated with each of the multiple types of resources that are part of the optimized project. The information associated with each of the multiple types of resources that are part of the optimized project includes resource-type identification, start-time for resource-acquisition, and a quantity of resources of the associated type of resource that is part of the optimized project.

At 210, the computing device reports the produced resource-acquisition plan for the optimized project.

With reference to FIG. 3, process 300 depicts an example of an implementation of operation 206 of determining an optimized project that performs successive genetic operations and evaluations. The process 300 may be performed by a computing device or devices. An example architecture of such a computer device is described below with reference to FIG. 4.

In process 300, a chromosome is encoded as a recruitment plan for all the projects. The length of a chromosome is MN. In the human resources example, M=3. That is because there are only 3 types of employees in this example. The numbers Q_{P}_{ₙ}_{E}_{ₘ} will represent the quantity of FTE, contract and intern, where n is (1, . . . , N) and m is (1, . . . , M).

In pseudocode, this setup may look as follows:

% NumOfChrom: number of chromosomes in GA population
% MaxGen: max number of generation
% CrosRate1: cross rate for crossover 1
% CrosRate2: cross rate for crossover 2
% MutaRate: mutation rate
%ParentChrom: parent chromosomes
% ChildChrom: child chromosomes
% InterChrom: combination of parent chromosomes and child
chromosomes

At 302, the computing system initializes the chromosomes. The initialization of the first generation is generated randomly with consideration of the delivery time and recruitment ceiling of each types of employee (e.g., recruitment budget or headcount). As the FTE's contract is more stable than other types of employee, which may have impact to the following projects, the short-term employee is a preferred choice for fixing the invalid chromosomes (i.e., repairing illegal chromosomes). For example, if a project cannot be delivered in time, the company's incentives to hire more contractors and interns may increase.

In pseudocode, the initialization may look as follows:

```
    % Initialization: a chromosome represents a possible solution of
human resource planning
    Initialize NumOfChrom chromosomes randomly
```

At 304, the computing system evaluates chromosomes according to a fitness function. From each chromosome, a recruiting plan for all the projects is generated. From the viewpoint of chromosome decoding, the whole recruiting schedule for the company can be deduced from the chromosome too.

For simplicity of this discussion, it is assumed that the intern is hired daily, which may be the same as the contractor. Then the following is how the cost of recruiting intern and contractor are calculated:

$${Cost}_{intern} = {C}_{intern} * {\sum }_{n = 1}^{N} {Q}_{{P}_{n} {E}_{2}}$$

$${Cost}_{contract} = {C}_{contract} * {\sum }_{n = 1}^{N} {Q}_{{P}_{n} {E}_{1}}$$

For this discussion, presume that the sequence of projects P₁, P₂, . . . , P_{N} is already ordered by project kick-off time. As the FTE resource will be released after the project is finished, for each project, the actual need of FTE can be calculated by checking E₁ and the available amount of FTE at the kick-off time. For this, the quantities of FTEs recruited at each project's kick-off time are Q′_{P}_{₁}_{E}_{₁}, . . . , Q′_{P}_{_{N}}_{E}_{₁} and the planning's end time is TPE. Based on this, the cost of recruiting FTEs may be as follows:

$${Cost}_{FTE} = {C}_{FTE} * {\sum }_{n = 1}^{N} ( TPE - {TK}_{{P}_{n}} ) * {Q}_{{P}_{n} {E}_{1}}^{′}$$

Then the fitness function is:

Fitness=Cost_{recruiting}=Costᵢₙₜₑᵣₙ+Cost_{contract}+Cost_{FTE}

More formally, the problem may be stated as follows:

$$Minimize \{ {Cost}_{recruiting} , where for all {P}_{n} , {\sum }_{m = 1}^{M , eg . M = 3} {Prod}_{m} * {Q}_{{P}_{n} {E}_{m}} \geq {W\_P}_{n}$$

At 306, the computing system selects parent chromosomes for genetic operation (e.g., crossover and/or mutation).

At 308, the computing system performs crossover and/or mutation on the two parent chromosomes. In genetic algorithms, crossover is a genetic operator used to vary the programming of a chromosome or chromosomes from one generation to the next. It is analogous to reproduction and biological crossover, upon which genetic algorithms are based. Crossover is a process of taking more than one parent solutions and producing a child solution from them. A mutation is a genetic operator used to maintain genetic diversity from one generation of a population of genetic algorithm chromosomes to the next. It is analogous to biological mutation. Mutation alters one or more gene values in a chromosome from its initial state. In mutation, the solution may change entirely from the previous solution.

For the crossover operation the two parent chromosomes are recombined. Different from conventional crossover on the whole chromosome, the proposed operator recombines genes within a randomly selected project block separately. This generates reasonable child chromosomes.

The crossover operation may be implemented for a random project in parent chromosome pairs. In the mutation operator, a gene is selected from a chromosome and shifted randomly.

At 310, the computing system updates the parent chromosomes according to the fitness value (based on the fitness function).

At 312, the computer system determines whether the number of generations (i.e., iterations) has reached a defined maximum or target value. If not, then the process 300 loops back to action 304. If it has reached that number of generations, then the process ends at 314.

In pseudocode, the actions of 304-312 loop might look as follows:

```
1. BEGIN
2. ParentChrom = Chromosomes
3. WHILE NOT CONVERGED
4. CALL FUNCTION Crossover (ParentChrom, CrosRate1,
        CrosRate2)
5. CALL FUNCTION Mutation (ParentChrom, MutaRate)
6. Combine ParentChrom and ChildChrom, which is denoted as
        InterChrom
            % Fitness Evaluation
7. CALL FUNCTION Fitness = Evaluate(InterChrom)
8. Sort InterChrom according to Fitness
9. Select the top NumOfChrom as ParentChrom for the next
        generation
10. ENDWHILE
11. END
  Evaluation
% FitnessValue: the value of evaluation function
1. FUNCTION Evaluation (Chrom)
2. BEGIN
3. FitnessVaue = 0
4. FOR EACH Project Pₙ
5. Cost_{recruiting,P}_{ₙ} = Cost_{intern,P}_{ₙ} + Cost_{contract,P}_{ₙ} + Cost_{FTE,P}_{ₙ}
6. FitnessValue += Cost_{recruiting,P}_{ₙ}
7. END FOR
8. END
  Mutation
% MutaRate: mutation rate
% ParentChrom: parent chromosomes
% ChildChrom: child chromosomes
% NumOfChildChrom: the number of child chromosome
1. FUNCTION ChildChrom = Mutation (ParentChrom, MutaRate)
2. BEGIN
3. IF rand( ) < MutaRate
4. Randomly select one parent chromosome
5. Randomly select one position where the mutation will happen
6. i=Find the corresponding Project ID
7. Randomly change the value of selected gene into others gene,
and fix the segment of Project i if Project i become invalid
8. END IF
9. END
  Crossover
% CrosRate: cross rate of Crossover
%ParentChrom: parent chromosomes
% ChildChrom: child chromosomes
1. FUNCTION ChildChrom = Crossover (ParentChrom, CrosRate)
2. BEGIN
3. Find all products by categorizing the components
4. WHILE NumOfChildChrom < NumOfChrom
5. IF rand( ) < CrosRate
6. Randomly select two parent chromosomes as Patent1 and
        Patent2
7. Randomly select genes in Patent1, and swap them with
Patent2's genes in the same position
8. IF the two new child is invalid
9. Fix them by adjusting the recruiting plan
10. END IF
11. END IF
12. END WHILE
13. END
```

FIG. 4 illustrates an exemplary system 400 that may implement, at least in part, the technologies described herein. The computer system 400 includes one or more processors, such as processor 404. Processor 404 can be a special-purpose processor or a general-purpose processor. Processor 404 is connected to a communication infrastructure 402 (for example, a bus or a network). Depending upon the context, the computer system 400 may also be called a client device.

Computer system 400 also includes a main memory 406, preferably Random Access Memory (RAM), containing possibly inter alia computer software and/or data 408.

Computer system 400 may also include a secondary memory 410. Secondary memory 410 may include, for example, a hard disk drive 412, a removable storage drive 414, a memory stick, etc. A removable storage drive 414 may comprise a floppy disk drive, a magnetic tape drive, an optical disk drive, a flash memory, or the like. A removable storage drive 414 reads from and/or writes to a removable storage unit 416 in a well-known manner. A removable storage unit 416 may comprise a floppy disk, a magnetic tape, an optical disk, etc. which is read by and written to by removable storage drive 414. As will be appreciated by persons skilled in the relevant art(s) removable storage unit 416 includes a computer usable storage medium 418 having stored therein possibly inter alia computer software and/or data 420.

In alternative implementations, secondary memory 410 may include other similar means for allowing computer programs or other instructions to be loaded into computer system 400. Such means may include, for example, a removable storage unit 424 and an interface 422. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 424 and interfaces 422 which allow software and data to be transferred from the removable storage unit 424 to computer system 400.

Computer system 400 may also include an input interface 426 and a range of input devices 428 such as, possibly inter alia, a keyboard, a mouse, etc.

Computer system 400 may also include an output interface 430 and a range of output devices 432 such as, possibly inter alia, a display, one or more speakers, etc.

Computer system 400 may also include a communications interface 434. Communications interface 434 allows software and/or data 438 to be transferred between computer system 400 and external devices. Communications interface 434 may include a modem, a network interface (such as an Ethernet card), a communications port, a Personal Computer Memory Card International Association (PCMCIA) slot and card, or the like. Software and/or data 438 transferred via communications interface 434 are in the form of signals 436 which may be electronic, electromagnetic, optical, or other signals capable of being received by communications interface 434. These signals 436 are provided to communications interface 434 via a communications path 440. Communications path 440 carries signals and may be implemented using a wire or cable, fiber optics, a phone line, a cellular phone link, a Radio Frequency (RF) link or other communication channels.

As used in this document, the terms “computer-program medium,” “computer-usable medium,” and “computer-readable medium” generally refer to media such as removable storage unit 416, removable storage unit 424, and a hard disk installed in hard disk drive 412. Computer program medium and computer usable medium can also refer to memories, such as main memory 406 and secondary memory 410, which can be memory semiconductors (e.g. Dynamic Random Access Memory (DRAM) elements, etc.). These computer program products are means for providing software to computer system 400.

Computer programs (also called computer control logic) are stored in main memory 406 and/or secondary memory 410. Such computer programs, when executed, enable computer system 400 to implement the present technology described herein. In particular, the computer programs, when executed, enable processor 404 to implement the processes of aspects of the above. Accordingly, such computer programs represent controllers of the computer system 400. Where the technology described herein is implemented, at least in part, using software, the software may be stored in a computer program product and loaded into computer system 400 using removable storage drive 414, interface 422, hard disk drive 412 or communications interface 434.

The technology described herein may be implemented as computer program products comprising software stored on any computer useable medium. Such software, when executed in one or more data processing devices, causes data processing device(s) to operate as described herein. Embodiments of the technology described herein may employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), and nanotechnological storage device, etc.).

A computing system may take the form of any combination of one or more of inter alia a wired device, a wireless device, a mobile phone, a feature phone, a smartphone, a tablet computer (such as for example an iPad™), a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), a cable system or other set-top-box, an entertainment system component such as a television set, etc.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Herein, a particular human resource planning scenario was discussed as a project management example in which the technology described herein may be utilized. The technologies described herein may be applied to other project management situations as well.

For example, rather than projects conducted by humans, more general tasks can be any activity with the following attributes: Time schedule where typically a start time and an end time would be sufficient (or alternatively a length of time); Quantifiable workload where many kinds of tasks can be quantified in the real world; for example, computation cost can be quantified as the CPU time needed. For more complicated tasks, some kind of estimation model may be employed to calculate the quantitative workload.

General resources are those resources assigned to complete general tasks. Different types of resources can be used, and substitutions can be allowed. For example, rather than human resources itself, more general resources can have the following attributes: Quantifiable efficiency where corresponding to the quantifiable workload in general tasks, resources used to complete those tasks should have quantifiable efficiency. For example, if a task is quantified as the requirement of computing capacity and storage capacity, the resource can be a computer. Its efficiency can be quantified as its CPUs' floating point operations per second, integer operations per second and its hard drive's capacity; Quantifiable costs which include the cost to acquire the resource, the operational costs as well as the cost induced by depreciation.

Similar to the recruitment plan discussed herein, this technology may generate a plan to acquire other resources. For example, rather than human resources action plan, the actions of a general project will have the following attributes: Time point which is the time point to perform this acquisition; Resource type, where there may be several different resources types for a task; Amount of resource to acquire.

As the optimization method employed is in a simulation-and-evaluation framework, once the optimization process is finished, the resource-acquisition plan is available. In general, the plan assigns certain amount of specific type resources to a task in a time window.

What is claimed is:

1. A method that facilitates project resource management, comprising:
obtaining project data regarding a subject project from a database server configured to store project data about the subject project, the project data includes information associated with the subject project, the information comprises a project identification, project start time, project delivery time, an expected-project-completion load or a combination thereof;
obtaining resource data from the database server, the resource data includes information regarding each resource available for use with the subject project to complete that project, the information for each resource comprises a resource-type identification, productivity rate, resource cost, resource-acquisition cost, resource-availability information or a combination thereof;
determining, based at least in part on the obtained project data and the obtained resource data, an optimized project;
producing a resource-acquisition plan for the optimized project, the resource-acquisition plan includes information associated with each of the multiple types of resources that are part of the optimized project, wherein the information associated with each of the multiple types of resources that are part of the optimized project comprises resource-type identification, start-time for resource-acquisition, a quantity of resources of the associated type of resource that is part of the optimized project, or a combination thereof; and
reporting the produced resource-acquisition plan for the optimized project.

2. The method according to claim 1, wherein each of the multiple types of resources differ from each other in the values of their respective associated information regarding any one or a combination of the productivity rate, the resource cost, the resource-acquisition cost, or the resource-availability information.

3. The method according to claim 1, wherein each of the multiple types of resources differ from each other in the values of their respective cost structure, wherein the cost structure of a resource is the associated information regarding the resource cost, the resource-acquisition cost, or the resource-availability information.

4. The method according to claim 1, wherein the determining the optimized project includes performing successive genetic operations and evaluations.

5. The method according to claim 4, wherein performing successive genetic operations and evaluations comprises evaluating the chromosomes according to a fitness function.

6. The method according to claim 5, wherein performing successive genetic operations and evaluations comprises selecting parent chromosomes for genetic operation.

7. The method according to claim 6, wherein performing successive genetic operations and evaluations comprises crossing-over contents of the parent chromosomes.

8. The method according to claim 7, wherein performing successive genetic operations and evaluations comprises mutating contents of a selected chromosome.

9. The method according to claim 8, wherein performing successive genetic operations and evaluations comprises updating parent chromosomes according to a fitness value calculated according to the fitness function.

10. The method according to claim 9, wherein performing successive genetic operations and evaluations comprises repeating the evaluating, selecting, crossing-over, mutating, and updating actions for a predetermined number of generations.

11. One or more computer-readable media storing processor-executable instructions that when executed cause one or more processors to perform operations that facilitates project resource management comprising:
obtaining project data regarding a subject project from a database server configured to store project data about the subject project, the project data includes information associated with the subject project;
obtaining resource data from the database server, the resource data includes information regarding each resource available for use with the subject project to complete that project;
determining based at least in part on the obtained project data and the obtained resource data, an optimized project;
producing a resource-acquisition plan for the optimized project; and
reporting the produced resource-acquisition plan for the optimized project.

12. The one or more computer-readable media according to claim 11, wherein each of the multiple types of resources differ from each other in values of their respective associated information regarding any one or a combination of productivity rate, resource cost, resource-acquisition cost, or resource-availability information.

13. The one or more computer-readable media according to claim 11, wherein each of the multiple types of resources differ from each other in values of their respective cost structure, wherein the cost structure of a resource is the associated information regarding resource cost, resource-acquisition cost, or resource-availability information.

14. A system for facilitating human-resources project resource management, comprising:
a non-transitory memory device for storing computer readable program code; and
a processor device in communication with the memory device, the processor device being operative with the computer readable program code to perform steps including
obtaining project data regarding a subject human-resources project from a database server configured to store project data about the subject human-resources project, the project data includes information associated with the subject human-resources project,
obtaining resource data from the database server, the resource data includes information regarding each human resource available for use with the subject project to complete the project,
determining, based at least in part on the obtained project data and the obtained resource data, an optimized project, wherein the determining includes performing successive genetic operations and evaluations, and
producing a recruitment plan for the optimized project, the recruitment plan includes information associated with each of the multiple types of human resources that are part of the optimized project.

15. The method according to claim 14, wherein each of the multiple types of human resources differ from each other in values of their respective associated information regarding any one or a combination of productivity rate, resource cost, recruitment cost, or resource-availability information.

16. The method according to claim 14, wherein each of the multiple types of human resources differ from each other in values of their respective cost structure, wherein the cost structure of a resource is the associated information regarding resource cost, recruitment cost, or resource-availability information.

17. The method according to claim 14, wherein the multiple types of human resources is selected from a group consisting of full-time employees (FTE), contractors, interns, externs, and part-time employees (PTE).

18. The method according to claim 14, wherein performing successive genetic operations and evaluations comprises:
initializing chromosomes with random values encoded for each of the multiple types of resources;
evaluating chromosomes according to a fitness function;
selecting parent chromosomes for genetic operation;
crossing-over contents of the parent chromosomes;
mutating contents of a selected chromosome;
updating parent chromosomes according to a fitness value calculated according to the fitness function; and
iteratively repeating the evaluating, selecting, crossing-over, mutating, and updating actions for a predetermined number of generations.

19. The method according to claim 18, wherein the fitness function is Fitness=Cost_{recruiting}=Costᵢₙₜₑᵣₙ+Cost_{contract}+Cost_{FTE}, wherein Cost_{recruiting} is cost of recruiting combined different types of human resources for a chromosome, Costᵢₙₜₑᵣₙ is the cost of recruiting an intern, Cost_{contract} is the cost of recruiting a contractor, and Cost_{FTE} is the cost of recruiting a full-time employee.

20. The method according to claim 14, wherein the reporting includes generating a user-interface with parameters indicating the recruitment plan for the optimized project, the recruitment plan comprises number of hires for each type of different human resource and timing of such hires.
